(19) United States
(12) Patent Application Publication
(10) Pub. No.: US 2016/0275081 A1
(43) Pub. Date: Sep. 22, 2016

(54) METHOD AND APPARATUS FOR PERSONALIZED RESOURCE RECOMMENDATIONS

(71) Applicant: NOKIA TECHNOLOGIES OY, Espoo (FI)

(72) Inventors: Jilei Tian, Beijing (CN); Yang Cao, Beijing (CN); Xiaogang Yang, Beijing (CN); Xin Xing Yang, Beijing (CN)

(21) Appl. No.: 14/773,646

(22) PCT Filed: Mar. 20, 2015
(86) PCT No.: PCT/CN2013/072944

§ 371 Date: Sep. 8, 2015

(51) Int. Cl. G06F 17/30

(52) U.S. Cl. CPC G06F 17/3053; G06F 17/30598; G06F 17/30327; G06F 17/30867

(57) ABSTRACT

An approach is provided for generating personalizing resource recommendations. A recommendation engine causes, at least in part, a classification of one or more items into a tree structure, wherein the tree structure is based, at least in part, on a hierarchical categorization of the one or more items, and wherein the one or more items are associated with a usage history of at least one user. The recommendation engine determines one or more candidate root nodes of the tree structure based, at least in part, on one or more user preference criteria. The recommendation engine determines one or more candidate sub-nodes associated the respective one or more candidate root nodes based, at least in part, on the usage history. The recommendation engine causes, at least in part, a ranking of the one or more candidate root nodes, the one or more candidate sub-nodes, or a combination thereof.

### BACKGROUND

Service providers and device manufacturers (e.g., wireless, cellular, etc.) are continually challenged to deliver value and convenience to consumers by, for example, providing compelling network services. One area of development has been the use of recommendation systems to provide users with suggestions or recommendations for content, items, resources, etc. available within the services and/or related applications (e.g., recommendations regarding people, places, or things of interest such as companions, restaurants, stores, vacations, movies, video on demand, books, songs, software, articles, news, images, etc.). For example, a typical recommendation system may suggest an item to a user based on user search and/or consumption history, user explicit preferences, prediction based on, for example, collaborative filtering that rely on large amounts of user data, etc. However, traditional recommendation systems often produce results that are granularity homogenous (e.g., the most favorable website recommendations tend to be at the top domain level such as cnn.com), thereby requiring user actions (e.g., clicking into the favorite granularity level within the top domain such as money.cnn.com/retirement/, and then bookmarking the favorite granularity level which leads to a potentially worse user experience). Accordingly, service providers and device manufacturers face significant technical challenges to enable recommendations at the favorite granularity level.

### SOME EXAMPLE EMBODIMENTS

Therefore, there is a need for personalizing resource recommendations.

According to one embodiment, a method comprises causing, at least in part, a classification of one or more items into a tree structure, wherein the tree structure is based, at least in part, on a hierarchical categorization of the one or more items, and wherein the one or more items are associated with a usage history of at least one user. The method also comprises determining one or more candidate root nodes of the tree structure based, at least in part, on one or more user preference criteria. The method further comprises determining one or more candidate sub-nodes associated the respective one or more candidate root nodes based, at least in part, on the usage history. The method further comprises causing, at least in part, a ranking of the one or more candidate root nodes, the one or more candidate sub-nodes, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a classification of one or more items into a tree structure, wherein the tree structure is based, at least in part, on a hierarchical categorization of the one or more items, and wherein the one or more items are associated with a usage history of at least one user. The apparatus is also caused to determine one or more candidate root nodes of the tree structure based, at least in part, on one or more user preference criteria. The apparatus is further caused to determine one or more candidate sub-nodes associated the respective one or more candidate root nodes based, at least in part, on the usage history. The apparatus is further caused to cause, at least in part, a ranking of the one or more candidate root nodes, the one or more candidate sub-nodes, or a combination thereof.

According to another embodiment, a computer-readable storage medium carries one or more sequences of one or more instructions which, when executed by one or more processors, cause, at least in part, an apparatus to cause, at least in part, a classification of one or more items into a tree structure, wherein the tree structure is based, at least in part, on a hierarchical categorization of the one or more items, and wherein the one or more items are associated with a usage history of at least one user. The apparatus is also caused to determine one or more candidate root nodes of the tree structure based, at least in part, on one or more user preference criteria. The apparatus is further caused to determine one or more candidate sub-nodes associated the respective one or more candidate root nodes based, at least in part, on the usage history. The apparatus is further caused to cause, at least in part, a ranking of the one or more candidate root nodes, the one or more candidate sub-nodes, or a combination thereof.

According to another embodiment, an apparatus comprises means for causing, at least in part, a classification of one or more items into a tree structure, wherein the tree structure is based, at least in part, on a hierarchical categorization of the one or more items, and wherein the one or more items are associated with a usage history of at least one user. The apparatus also comprises means for determining one or more candidate root nodes of the tree structure based, at least in part, on one or more user preference criteria. The apparatus further comprises means for determining one or more candidate sub-nodes associated the respective one or more candidate root nodes based, at least in part, on the usage history. The apparatus further comprises means for causing, at least in part, a ranking of the one or more candidate root nodes, the one or more candidate sub-nodes, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-22 and 38-40.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating resource recommendations at personalized favorite granularity levels, according to one embodiment;

FIG. 2 is a diagram of the components of a recommendation engine, according to one embodiment;

FIG. 3 is a flowchart of a process for generating resource recommendations at personalized favorite granularity levels, according to one embodiment;

FIG. 4 a diagram of a hierarchical structure of a website, according to one embodiment;

FIG. 5 a diagram of a hierarchical structure of a website depicted with score and energy values, according to one embodiment;

FIGS. 6A-6B are diagrams of user interfaces utilized in the processes of FIGS. 3-4, according to various embodiments;

FIGS. 7A-7B are diagrams of user interfaces utilized in the processes of FIGS. 3-4, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for personalizing resource recommendations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “resource” refers to a piece of data that is addressable or otherwise identifiable so as to be provided by a database/service (e.g., the Internet, a private network, local device storage, network storage, etc.) to its users or allows its users to share. Each resource can be modeled as one node in a tree structure, which makes it hardly learnt via data mining on user history data. Taking website as a resource example, it can be organized as edition.cnn.com as domain/root node. Under the root node edition.cnn.com, there are subtree nodes such as edition.cnn.com/ASIA, edition.cnn.com/EUROPE, etc. Taking book as another resource example, the tree structure can be divided into branches including science, technology, arts, etc., and the science branch can be further divided into branches such as mathematics, physics, etc., and the physics branch can be further divided into several subcategories, and so forth. By way of example, resources may include web pages, documents, audio, video, multimedia files, images, services, applications, films, television, books, music, videos, news, images, etc. In one embodiment, resources are identified using a Uniform Resource Identifier (URI) that can encompass both a Uniform Resource Locator (URL) and/or a Uniform Resource Name (URL). It is also contemplated a resource may be identified using any network naming or identification system.

Although various embodiments are described with respect to a web browser, it is contemplated that the approach described herein may be used with other platforms or services used with other resources, such as databases/libraries/folders, online book/movie/music, e-commerce reservations (e.g. restaurant.com, e-shopping.com, tickets.com, movies.com, etc.), application stores, etc.

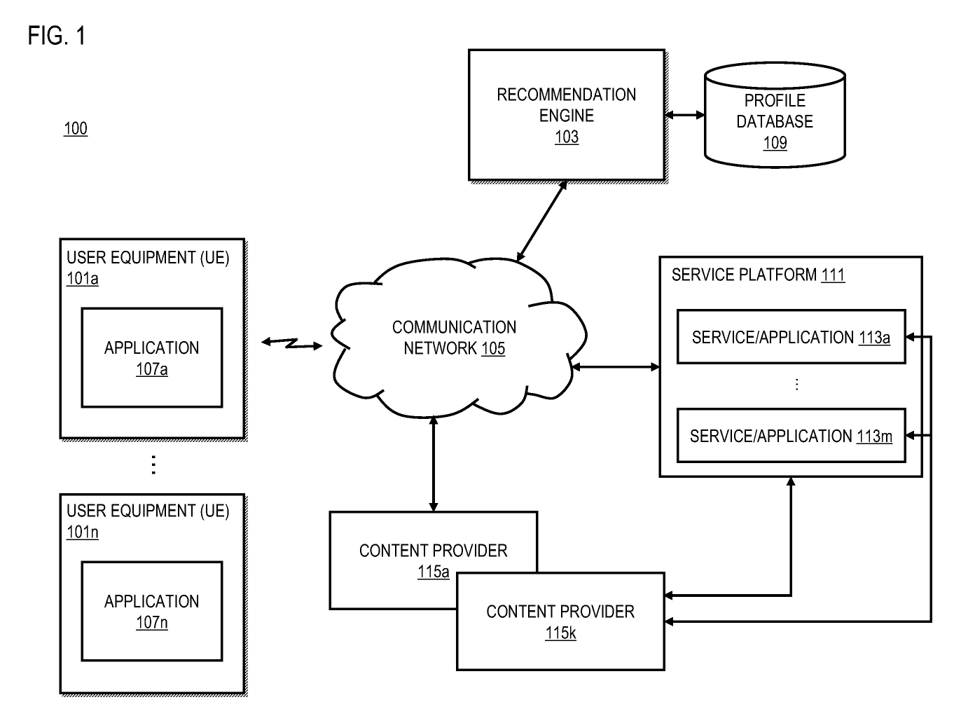

FIG. 1 is a diagram of a system capable of generating resource recommendations at personalized favorite granularity levels, according to one embodiment. User browsing history can be used by users to easily access their favorable web sites, but it eventually becomes a very long list of websites that requires the users take time to manage (e.g., bookmarking, organizing by folders, sequencing by time or alphabet, etc.) and find the favorable websites.

Modern recommendation systems provide users with a number of advantages over traditional methods of search in that recommendation systems circumvent the time and effort of searching for items of interest. Algorithmic approaches can be deployed to learn a user's most frequently visited websites from the browsing history. However, recommendation systems tend to pre-set a recommendation at a fixed level (e.g., a top domain such as cnn.com), regardless of what algorithms are used (e.g., collaborative filtering (CF) or content-based algorithms). The favorable websites (cnn.com/sports/) may not be necessary to be a root (host) website as set by an algorithm. It should vary according to user's behavior, rather forced to be at a pre-set granularity level. From the perspective of user experience, most recommendation engines aim to assist users to find new resources, such as new websites or new contents. There is a need to find the most favorable or the most visited/browsed resources (e.g., websites).

Traditional recommendation systems usually rank or sort the recommendation results with very similar content next to each other in the sort list. Consequently, the sort list can have long lists of the same or similar items immediately adjacent to each other. This, in turn, may cause inconvenience or boredom for the consumer who wants to browse a greater variety of items.

Moreover, traditional approaches to personalizing resource recommendations typically depend on modifying recommendation algorithms and then reprocessing the underlying data based on the modified algorithms. This process is often resource intensive (e.g., in terms of computational resources, storage, bandwidth, etc.) and can take a significant amount of time to complete. The time and resource burden can be problematic particularly when recommending items that have short or quick lifespans which can require at least near real-time processing. By way of example, deals (e.g., coupons, discounts, offers, group shopping offers, etc.) are one class of potentially short lifespan items. Most deals are valid for a relatively short period time (e.g., typically one to several days).

To address this problem, a system 100 of FIG. 1 introduces the capability to generate resource recommendations at personalized favorite granularity levels. In one embodiment, the system 100 classifies resource items based, at least in part, on one or more features such as category, keywords, tags, item type, information source, item location, etc., into a tree structure. The system 100 then processes the features to calculate usage/consumption information (e.g., browsing, downloading, checking out, etc.) associated with the one or more items/nodes, such as usage counts, score, energy with respect to the root node, patent nodes, sibling nodes, child nodes, etc. The system 100 then ranks the nodes based upon the calculated usage counts, score, energy, and recommends the favorite resources (e.g., websites at personalized favorite granularity levels) accordingly.

In one embodiment, the system 100 learns from a user's browsing history the user's one or more frequently visited websites, and adapts/updates the frequently visited websites to the user's behavior changes.

In one embodiment, the system 100 hierarchically classifies one or more resources into a tree structure, based upon a usage history of at least one user. The system 100 determines one or more candidate/favorable root nodes (e.g., bbc.co.uk) of the tree structure based, at least in part, on one or more user preference parameters and/or criteria. The system 100 determines one or more candidate/favorable sub-nodes (e.g., bbc.co.uk/news, or bbc.co.uk/news/uk-20284124) associated the respective one or more candidate root nodes based, at least in part, on the usage history, and the system 100 ranks the one or more candidate root nodes, the one or more candidate sub-nodes, or a combination thereof. When user visits this website (e.g., bbc.co.uk), all sub-websites are taken into account.

In one embodiment, the system 100 determines one or more favorable websites based on parameters such as browsing counts, recency, density/frequency, decay, adaptation, etc. In one embodiment, the system 100 sets criteria of a favorite website as meeting a predetermining browsing count threshold, or as being browsed more than other websites. By way of example, when a user visits A website 10 times, and visits B website 100 times, website B should be more favorable than website A.

In another embodiment, the system 100 sets those recently visited websites with higher weights than those visited in the past. By way of example, when a user visits A website 10 times January 2013, and visits B website 10 times February 2013, and it is in March 2013 now, website B should be more favorable than website A.

In another embodiment, the system 100 sets those websites visited more frequently in a set time period with higher weights than those less frequently visited in the in the same time period. By way of example, when a user visits A website 10 times in one month, and visits B website 10 times in a week, website B should be more favorable than website A.

In another embodiment, the system 100 faces out those past visited websites in order to allow user interest drifting. In another embodiment, the system 100 adapts favorable websites to include a new website after the user is using the browser for a long time but changes behaviors. By way of example, the user visits a website every month. The system 100 updates the scores every two weeks may eliminate such a website. In this embodiment, the system 100 analyzes the user browsing behavior and detects such a pattern thus adapts the favorite website accordingly.

In one embodiment, the system 100 determines the most browsed web sites to ease user's access by calculating data such as URL visit counts, etc. using algorithms such as link analysis algorithms (e.g., PageRank® Hyperlink-Induced Topic Search®, CheiRank®, TrustRank®, etc.). Link analysis provides the relationships and associations between many objects of different types that are not apparent from isolated pieces of information. In this embodiment, the system 100 does not feed content semantics information into a topic model (e.g., latent Dirichlet allocation), to combine with user's usage for inference, reasoning and prediction web content.

In one embodiment, the system 100 deploys a two-step approach by selecting candidate domains among all websites, selecting the most favorable website for each of the candidate domains, and then ranking the top-N favorable websites among all the candidate domains. “Domain” refers to a root website, such as cnn.com, but not cnn.com/sports, while “website” refers to any website, such as cnn.com, cnn.com/sports, etc. A domain website or root node can expand and form one tree and all leaf notes/websites can degenerate to a domain as a root to the tree.

In one embodiment, the system 100 collects statistics from an individual browsing history to form a tree. For such a given tree, each node is represented as a n-tuple of nodei. The n can be any nonnegative integer.

By way of example, 5-tuple nodei is defined as (Nc, Ns, count, score, energy). Nc indicates an exact click/browse number for a given website/nodei. Ns indicates a click/browse number for all the website nodes under nodei in the tree. Count indicates a newly increased click/browse count. Score, energy stand for the score and energy of nodei.

The score of each URL that the user visited at time t is represented as scoret (url), and the score for the domain that the user visited at time t is represented as scoret (domain) Assuming the user visited website url, e.g. www.cnn.com/sports/ at time t+1, domain (url)=cnn.com while url=cnn.com/sports. A Score for nodei from the leaf to the root in the tree can be updated iteratively as follow:

$$\begin{matrix}{N}_{c , t + 1} ( url ) = α * {N}_{c , t} ( url ) + ( 1 - α ) * count ( url ) & ( 1 ) \\ {N}_{s} ( url ) = {\sum }_{j , j is direct child of url}^{ } ( {N}_{c} ( {url}_{j} ) + {N}_{s} ( {url}_{j} ) ) & ( 2 ) \\ {score}_{t + 1} ( url ) = {N}_{c , t + 1} ( url ) & ( 3 ) \\ {score}_{t + 1} ( domain ) = [ {N}_{s , t + 1} ( domain ) + {N}_{c , t + 1} ( domain ) ] & ( 4 )\end{matrix}$$

As the tree gets larger, the system 100 can improve the efficiency via different methods, such as tree pruning, efficient score update, top domain finding, etc.

a =decay. If a=0, Nc now is equal to count (url), which means there is only current data and no historical data. If a =1, Nc now is equal to historical Nc, without current/new data. The system 100 sets 0<a<1 (e.g., α=0.8) to balance the data depending on the nature of the resources (e.g., websites).

In one embodiment, the system 100 prunes away one node at issue and the subsequent nodes under the node, when the node meets the following criterion at a pruning time t scoret (url)<Threshold. In some embodiments, the Threshold is decided based on keeping a fixed/maximum/minimum amount of URLs in the tree alive. In other embodiments, the Threshold is decided based on pruning a fixed/maximum/minimum amount of URLs beneath the node.

In another embodiment, the system 100 prunes away sibling nodes at issue and the subsequent nodes under the sibling nodes, when the sibling nodes meet the following criterion at a pruning time t Σ score jt (url)<Threshold. In some embodiments, the Threshold is decided based on keeping a fixed/maximum/minimum amount of URLs in the tree alive. In other embodiments, the Threshold is decided based on pruning a fixed/maximum/minimum amount of URLs beneath the sibling nodes.

In one embodiment, the system 100 efficiently updates the scores by updating those nodes/urls having a click/browse count during time t to t+1, while skipping updating scores for nodes/urls that do not have click/browse count (count(url)=0). Updating scores for all urls in the tree will lead to extreme computational cost. When a max (score) exceeds a predetermined value, the system 100 normalizes the entire tree by adjusting the α value in the following formula to avoid overflow.

$${score}_{t + 1} ( url ) = {score}_{t - n - 1} ( url ) + \frac{1}{{α}^{n}} * {N}_{c , t + 1} ( url ) , 0 < α < 1.0 \qquad ( 5 )$$

In one embodiment, the system 100 efficiently updates the scores by adjusting an updating frequency based upon the nature of the resources. By way of example, the system 100 updates the counts every week instead of everyday for drifted user interest, to conserve calculation resources.

In another embodiment, the system 100 ranks the domain scores at a given time (after all the domain scores were updated), and uses the top-N ranked domains (N is a non-negative integer, such as six) as the user's top favorite domain. For each given selected domain, the system 100 applies the following algorithm to find a user favorite websites within given selected domain.

For each node in the tree, the system 100 already calculated the score (node) as discussed, and defines Ns(node) as:

N_{S}(node)=Σ_{j,j is direct child of node} (N_{c}(nodeⱼ)+Nₛ(nodeⱼ)) (6)

For a leaf node j, Ns (nodei)=0. In other words, Ns (node) represents the score sum of all nodes which are directly under the node of interest. The system 100 defines the energy for nodei as:

$$\begin{matrix}energy ( node ) = score ( node ) + α * {N}_{s} ( node ) * entropy ( node ) & ( 7 ) \\ entropy ( node ) = - {\sum }_{j , j is direct child of node} \frac{energy ( {node}_{j} )}{\sum energy ( {node}_{i} )} log ( \frac{energy ( {node}_{j} )}{\sum energy ( {node}_{i} )} ) & ( 8 )\end{matrix}$$

The entropy measures the uncertainty or difficulty to select the favorable website from the direct child nodes j. If all the child nodes have same energy, the entropy is at a maximum which indicates there is no clear dominant child node (website) can be selected therefrom. The burden of decision is thus shifted to the parent node. If the entropy of a node is high, it means all child nodes are not representative, so it is better to use the node at issue as the representative node. Otherwise, if the entropy of the node at issue is low, it means one of the child nodes dominates the user clicking/browsing behavior under the node at issue, so the node at issue may be less representative for the child nodes. By way of example, BBC websites has a tree structure, and if the user browsed mostly bbc.com/sport, then bbc.com/sport is recommended. However, if the user browsed bbc.com/sport and bbc.com/news equally, bbc.com is recommended.

The system 100 calculates energy of the entire tree recursively. For a leaf node, α=1, so energy (node)=score (node). The system 100 iteratively calculates energy for a parent node using equations (6)-(8) until reaching the root node. The system 100 selects the URL corresponding to the node, which has the biggest energy, as the user favorite URL for a given domain.

In this example, the system 100 calculates the entropy with all known statistics, and then looks for the best node/url that has the largest energy that forms from several values including node entropy. In short, the system 100 uses node visit counts to calculate node entropy and node energy, and then selects the node with the largest energy as a favorite node corresponding to a favorite website. In one embodiment, the system 100 sets a predetermined number of shortcut buttons on a browser UI for the favorite websites, and clicking the button will lead the user to the websites directly without typing anything to the browser address field. In another embodiment, the system 100 automatically updates the short cuts based on the user's browsing activities to web sites, such as when one or more browsing counts meet the respective threshold values. The updating process is relatively lightweight from a resource burden standpoint (e.g., requires relatively small amounts of computational resources) and can be performed quickly or in substantially real time.

In another embodiment, the system 100 applies the same approach within a native application, such as calendar/email/contact/tasks/albums or within a non-native application, such as games, massagers, voice over IP application, social networking web applications (e.g., LinkedIn, Facebook, Meetup, etc.), classified advertisements websites (e.g., craigslist), etc. By way of example, the system 100 displays under an Inbox folder only six mostly used folders regardless the granularity levels of the folders, instead of showing all available folders in a tree structure. As another example, the system 100 displays only six mostly communicated/browsed contacts in the LinkedIn contact page regardless the contact levels (direct contacts, secondary contacts, etc.).

In another embodiment, the system 100 applies the same approach to an OS home screen, an application directory, or an application store that has a tree structure. By way of example, the system 100 displays on a mobile device home screen six shortcuts to only six mostly used applications, instead of showing all available mobile applications.

In another embodiment, the system 100 applies the same approach to an online book/movie/music store with content items classified into a tree-like structure. By way of example, the system 100 shows only six mostly viewed series by the user as “House of Cards,” “Breaking Bad,” “MasterChef,” etc. in the Netflix® video check-out page. As another example, the system 100 shows only six mostly checked out audio eBooks by the user as “Lonely Planet-South Africa,” “Spanish on the Go,” etc. in the country library check out page.

In another embodiment, the system 100 applies the same approach to an online app/podcasts store with content items classified into a tree-like structure. By way of example, the system 100 shows only six mostly downloaded applications in the application check-out page. As yet another example, the system 100 shows only six mostly downloaded podcasts by the user as “Freakonomics,” “TEDTalks,” “Human Rights Watch,” etc. in the podcasts library page.

In another embodiment, the system 100 applies the same approach to e-commerce points of sale which directory is classified into a tree-like structure. By way of example, the system 100 shows only six points of sale frequently browsed by the users as yelp.com (restaurants/services), cnet.com (electronics), amazon.com (e-shopping), cheaptickets.com (travel arrangements), etc.

In one embodiment, the system 100 improves efficiency by using a common framework for generating resource recommendations at personalized favorite granularity levels for multiple applications, the common framework of the system 100 enables the usage/consumption information collected from one or more applications to be used to generate recommendations for another application. For example, some subsets of data in the content usage information may be relevant to a particular application and not to other applications, while other subsets are relevant to the other applications, but not to the particular application. Thus, the content usage information may support the generation of a plurality of resource recommendations at personalized favorite granularity levels for a plurality of applications. Furthermore, the same resource recommendations at personalized favorite granularity levels may be reused in such an environment where the models are applicable to a plurality of applications. A circumstance where previously generated resource recommendations at personalized favorite granularity levels for an application may be provided to other applications is, for instance, where there is some relationship between the application and the other applications that would indicate similar items and users (e.g., a jazz music blog and a jazz music store program).

In one embodiment, the system 100 automatically generate, at a recommendation engine, resource recommendations at personalized favorite granularity levels for an application.

In another embodiment, the system 100 may receive a request, at a recommendation engine, for generating resource recommendations at personalized favorite granularity levels for an application, wherein the recommendation engine is applicable to a plurality of applications. The request may be received from or transmitted by the application for which the resource recommendations at personalized favorite granularity levels is to be generated. Moreover, the request may be made by one or more users (e.g., administrators, developers, regular users, etc.) of the application, for instance, to improve the recommendations produced by the application. The system 100 may then retrieve content usage information from one or more profiles associated with the application, one or more other applications, or a combination thereof.

In another embodiment, the system 100 further uses maximum entropy (ME) as a framework to estimate/optimize the unknown parameters, and recommend new website. The system 100 collects the statistics as the constraint. Given and met the constraint, the system 100 estimates the unknown parameters based on ME assumption to be optimized. By way of example, the system 100 recommends the user new urls to be accessed, such as news, new music/movie, etc.

In one embodiment, the adjustment of the recommendation scores can be performed as a post-processing step following generation of the recommendations at personalized favorite granularity levels. Accordingly, the various embodiments of the approach described herein are compatible with any recommendation technology including CF-based recommendations and content-based recommendations at a post-processing basis.

As shown in FIG. 1, the system 100 comprises a user equipment (UE) 101 or multiple UEs 101a-101n (or UEs 101) having connectivity to a recommendation engine 103 via a communication network 105. A UE 101 may include or have access to an application 107 (or applications 107), which may comprise of client programs, services, or the like that may utilize a system to provide recommendations to users.

As users utilize the applications 107 on their respective UEs 101, the recommendation engine 103 may collect content usage information (e.g., data indicating how a user might rate an item) from the applications 107. By way of example, content usage information collection might include asking a user to rate an item on a scale of one through ten, asking a user to create a list of items that the user likes, observing items that the user views, obtaining a list of items that the user purchases, analyzing the user's viewing times of particular items, etc. Likewise, the recommendation engine 103 may also provide the applications 107 with resource recommendations at personalized favorite granularity levels based on the content usage information that the applications 107 may utilize to produce intelligent recommendations to its users. As such, the recommendation engine 103 may include or be connected to a profile database 109 in order to access or store content usage information. Within the profile database 109, the content usage information may be stored or associated with, for instance, one or more respective user profiles. It is noted, however, that the profile database 109 may also contain other profile types, such as application profiles, item profiles, etc.

As shown, the UEs 101, the recommendation engine 103 also has connectivity to a service platform 111 hosting one or more respective services/applications 113a-113m (also collectively referred to as services/applications 113), and content providers 115a-115k (also collectively referred to as content providers 115). In one embodiment, the services/applications 113a-113m comprise the server-side components corresponding to the applications 107a-107n within the UEs 101. In one embodiment, the service platform 111, the services/applications 113a-113m, the application 107a-107n, or a combination thereof have access to, provide, deliver, etc. one or more items associated with the content providers 115a-115k. In other words, content and/or items are delivered from the content providers 115a-115k to the applications 107a-107n or the UEs 101 through the service platform 111 and/or the services/applications 113a-113n.

In some cases, a developer of the services/applications 113a-113m and/or the applications 107a-107n may request that the recommendation engine 103 generate one or more resource recommendations at personalized favorite granularity levels with respect to content or items obtained from the content providers 115a-115k. The developer may, for instance, transmit the request on behalf of the application 107 and/or the services/applications 113 to the recommendation engine 103 for the purpose of generating resource recommendations at personalized favorite granularity levels. After receiving the request for resource recommendations, the recommendation engine 103 may then retrieve content usage information from one or more profiles associated with the application 107, the services/applications 113, one or more other applications, or a combination thereof.

The recommendation engine 103 may further generate the resource recommendations at personalized favorite granularity levels based on the content usage information. Because the content usage information may be derived from the one or more profiles associated with the application 107, the services/applications 113 and/or the one or more other applications, the generation of the resource recommendations at personalized favorite granularity levels is not limited only to profiles associated with the application 107 for which the generation request was made. Thus, even if the application 107 has few or no users, prior to the generation request, the recommendation engine 103 may still be able to generate resource recommendations at personalized favorite granularity levels with enough data to produce accurate predictions with respect to suggesting items of interest to users.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In an embodiment, the recommendation engine 103 extracts a subset of the content usage information based on a relevance to a particular application. In a further embodiment, the generation of the resource recommendations at personalized favorite granularity levels may also be based on the subset extracted from the content usage information. By way of example, the content usage information can be mapped from item-based content usage to feature-based content usage. In addition or alternatively, content usage may be provided directly for the features or categories of the items. In one sample use case, a movie streaming application may make a request for resource recommendations at personalized favorite granularity levels to provide its users with recommendations.

In another embodiment, a schema is determined for specifying the content usage information across multiple applications (e.g., applications 107, services/applications 113). The schema may be used to determine, for instance, the format or structure of the content usage information with respect to both items and/or features. In one embodiment, the schema may specify one or more taxonomies for defining features. In this way, the features can be standardized across one or more classes of items. By way of example, the schema may define elements and attributes that may appear in the content usage information, the order and number of element types, data types for elements and attributes, default or fixed values for elements and attributes, etc. Elements defined by the schema may include application classifications, item categories, usage types, users, relationships, etc. In one sample use case, a basic or a skeleton schema for specifying the content usage information may be predefined. However, application developers may be able to extend the basic or skeleton schema, for instance, by providing a new namespace. In yet another embodiment, the content usage information is collected from the application, the one or more other applications, or a combination thereof based on the schema. In a further embodiment, the collected content usage information is also stored based on the schema. In this way, the operations of the recommendation engine 103 are generally made more efficient. For example, the recommendation engine 103 may access data (e.g., the content usage information) in the profile database 109 to generate resource recommendations at personalized favorite granularity levels for any application without first having to figure out how to interpret the data since the schema is already provided.

In another embodiment, the collected content usage information is aggregated in respective ones of the one or more profiles. It is noted, however, that the profile database 109 may also contain other profile types, such as application profiles, item profiles, etc. By way of example, user profiles in the profile database 109 may include names, locations, age, gender, race/ethnicity, nationality, items viewed, item viewing times, items searched, items downloaded/uploaded, items purchased, items added to a wish list, shopping cart, or favorites list, items rated and how they were rated, etc. Accordingly, the one of more profiles may be accessed to provide the content usage information to generate resource recommendations at personalized favorite granularity levels for one or more applications.

In another embodiment, one or more relationships between a first portion of the content usage information associated with the application and a second portion of the content usage information associated with at least one of the one or more other applications is determined In yet another embodiment, the generation of the resource recommendations at personalized favorite granularity levels is further based on the one or more relationships. In one sample use case, the content usage information may contain data associated with a movie streaming service and also data associated with an e-reader program. The recommendation engine 103, for instance, may determine that a relationship exists between data associated with the romance genre of the movie streaming service and data associated with the romance genre of the e-reader program. As a result, the resource recommendations at personalized favorite granularity levels generated based on the romance genre relationship may indicate, for instance, that users that like e-books and romance movies have similar interests as users that like movies and romance e-books. In a further embodiment, the determination of the one or more relationships is based on the schema, a semantic analysis of the content usage information, or a combination thereof. By way of example, the determination of the relationships may be based on the schema if the relationships are defined in the schema, based on the semantic analysis if the relationships are absent from the schema, or based on both if some relationships are defined and others relationships are not.

In another embodiment, the resource recommendations at personalized favorite granularity levels is updated based on a predetermined frequency, a predetermined schedule, a detection of one or more updates to the content usage information, or a combination thereof. It is noted that resource recommendations at personalized favorite granularity levels updates may be desired in many cases, but also necessary to continue to offer useful suggestions in other cases. For example, resource recommendations at personalized favorite granularity levels updates may be required when usage change. As such, past behavior of users may no longer be helpful in making accurate recommendations. Thus, in a further embodiment, usage indications in the content usage information may contain timestamps. In this way, old data may be filtered out from the content usage information when generating resource recommendations at personalized favorite granularity levels for particular applications where, for instance, user usages have changed for those applications.

By way of example, the resource recommendations at personalized favorite granularity levels may define a user vs. item matrix, wherein the matrix indicates how each user might rate a particular item. In addition, the resource recommendations at personalized favorite granularity levels may define a user vs. feature matrix, wherein the matrix indicates how each user used a particular feature or category of the items. In one embodiment, the indications of the usages may be expressed, for instance, by a numerical value after each user profile variable (e.g., items viewed, item viewing times, items searched, items downloaded/uploaded, items purchased, items added to a wish list, shopping cart, or favorites list, items rated and how they were rated, etc.) has been computed after being assigned a determined weight based on the application and/or other criteria. In one embodiment, the numerical value can be normalized to a particular scale or range (e.g., a value between 0 and 1). The matrix may also provide the indications simply by presenting the variables to the application. In this way, the application may assign weights to each variable and compute how each user used the items based on the assigned variable weights.

In some embodiments, the recommendation matrix may be generated based, at least in part, on one or more additional parameters specified by the user, the recommendation engine 103, and/or another component of the system 100. It is noted that the parameters are often dependent on the nature of the applications, service, items, etc. relevant to service and are often specific to a particular recommendation model.

In another embodiment, the content usage information supports generation of a plurality of resource recommendations at personalized favorite granularity levels. As provided, there are many instances where the content usage information may support the generation of a plurality of resource recommendations at personalized favorite granularity levels. In one sample use case, a movie streaming service may make a request for resource recommendations at personalized favorite granularity levels to provide its users with recommendations. The recommendation engine 103 may extract a subset of the content usage information retrieved from the one or more profiles in the profile database 109 based on a relevance to the movie streaming service, such as data associated with movies. Accordingly, the different subsets of the content usage information may support the generation of more than one resource recommendations at personalized favorite granularity levels.

By way of example, the UE 101, the recommendation engine 103, and the application 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the corresponding service platform 111, services 113a-113m, the content providers 115a-115k, or a combination thereof interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

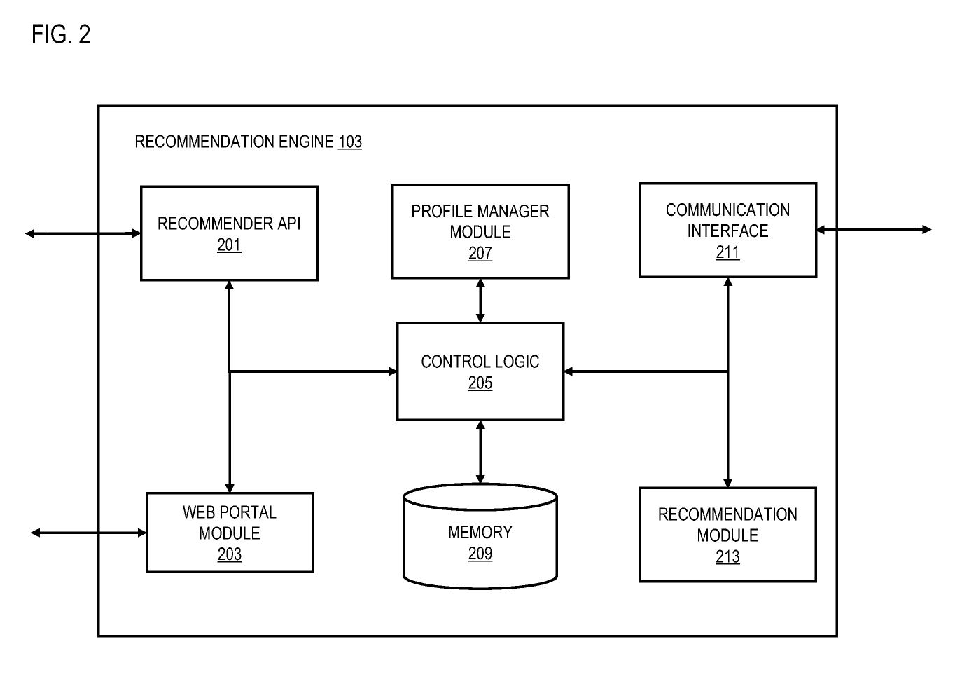

FIG. 2 is a diagram of the components of a recommendation engine, according to one embodiment. By way of example, the recommendation engine 103 includes one or more components for generating resource recommendations at personalized favorite granularity levels. It is contemplated that the functions of these components may be combined in one or more components or performed by other components of equivalent functionality. In this embodiment, the recommendation engine 103 includes a recommendation API 201, a web portal module 203, control logic 205, a memory 209, a communication interface 211, and a recommendation module 213.

The control logic 205 can be utilized in controlling the execution of modules and interfaces of the recommendation engine 103. The program modules can be stored in the memory 209 while executing. The communication interface 211 can be utilized to interact with UEs 101 (e.g., via a communication network 105). Further, the control logic 205 may utilize the recommendation API 201 (e.g., in conjunction with the communication interface 211) to interact with the diversification manager 102 as well as with the applications 107, the service platform 111, the services/applications 113, other applications, platforms, and/or the like.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the control logic 205 to communicate with the UEs 101a-101n, and other devices. In some examples, the communication interface 211 is used to transmit and receive information using protocols and methods associated with the recommendation API 201.

By way of example, the web portal module 203 may be utilized to facilitate access to modules or components of the recommendation engine 103, for instance, by developers. Accordingly, the web portal module 203 may generate a webpage and/or a web access API to enable developers to test or register their applications with the recommendation engine 103. Developer may further utilize the web page and/or the web access API to transmit a request to recommendation engine 103 for the generation of resource recommendations at personalized favorite granularity levels for their applications.

Moreover, the profile manager module 207 may manage, store, or access data in the profile database 109. As such, the profile manager module 207 may determine how data from the content usage information should be stored or accessed (e.g., based on a schema). In addition, the recommendation module 213 may handle the generation of resource recommendations at personalized favorite granularity levels. Thus, the recommendation module 213 may interact with the profile manager module 207, via the control logic 205, to obtain the content usage information in order to generate the resource recommendations at personalized favorite granularity levels. As such, the recommendation module 213 may further act as a filter in generating the resource recommendations at personalized favorite granularity levels from the content usage information such that data that does not meet certain criteria, such as relevance to a particular application, is not utilized in generating the resource recommendations at personalized favorite granularity levels.

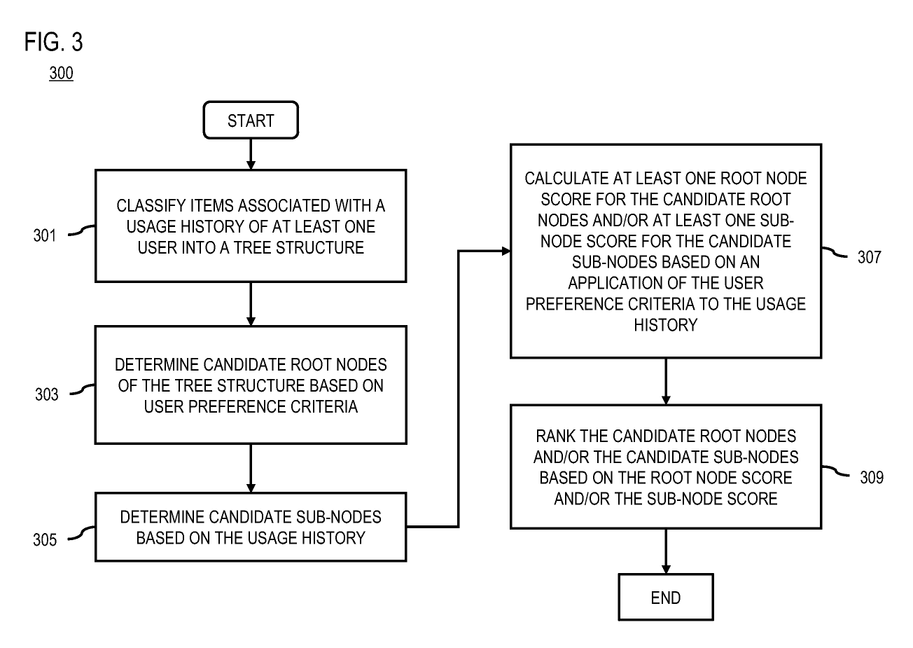

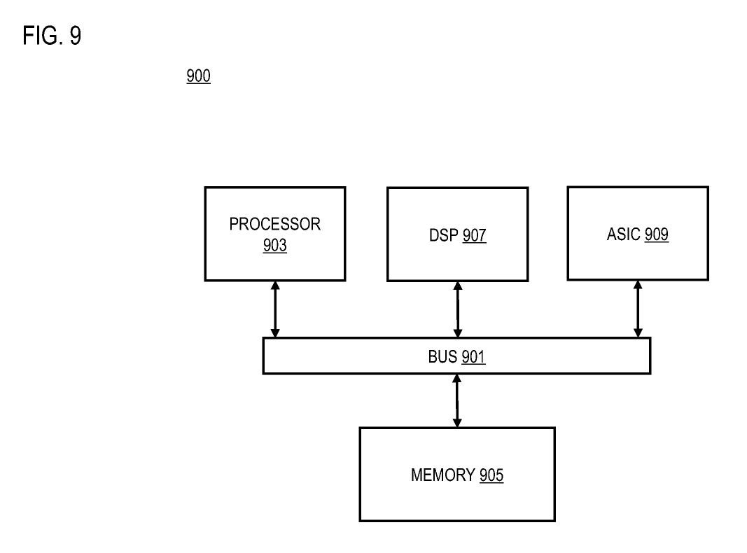

FIG. 3 is a flowchart of a process for generating resource recommendations at personalized favorite granularity levels, according to one embodiment. In one embodiment, the recommendation engine 103 performs the process 300 and is implemented in, for instance, a chip set including a processor and a memory as shown in FIG. 9. In step 301, the recommendation engine 103 causes, at least in part, a classification of one or more items into a tree structure (e.g., Restaurant->Chinese Cuisine->SiChuan Cuisine->etc.), wherein the tree structure is based, at least in part, on a hierarchical categorization of the one or more items, and the one or more items are associated with a usage history of at least one user.(e.g., time, frequency of browsing the websites, etc.) The one or more items are associated with one or more Internet domains (e.g., yelp.com), one or more sub-domains (e.g., yelp.com/DC) of the one or more Internet domains, or a combination thereof.

In step 303, the recommendation engine 103 determines one or more candidate root nodes (e.g., yelp.com/DC, yelp.com/NOVA, etc.) of the tree structure based, at least in part, on one or more user preference criteria. The user preference criteria are based, at least in part, on an access count for the one or more items, a recency of access to the one or more items, a density (frequency) of access to the one or more items, a decay parameter (e.g., a), an adaption parameter, or a combination thereof. By way of example, the recommendation engine 103 adapts favorable websites with different weighting factors after detecting a monthly browsing pattern of one website thus adapting the favorite website accordingly, even though the recommendation engine 103 updates the scores every two weeks may eliminate such a website. In this embodiment, the recommendation engine 103 analyzes the user browsing behavior and detects such a pattern thus adapts the favorite website accordingly.

In step 305, the recommendation engine 103 determines one or more candidate sub-nodes (e.g., yelp.com/DC, yelp.com/NOVA, etc.) associated the respective one or more candidate root nodes (e.g., yelp.com) based, at least in part, on the usage history (e.g., time, frequency, length of browsing).

In step 307, the recommendation engine 103 causes, at least in part, a calculation of one at least one root node score (e.g., 7 by calculating iteratively with formula (4)) for the one or more candidate root nodes (e.g., yelp.com), at least one sub-node score (e.g., 5 by calculating iteratively with formula (1)-(3)) for the one or more candidate sub-nodes (e.g., yelp.com/DC), or a combination thereof based, at least in part, on an application of the one or more user preference criteria (e.g., time, location, activity, etc.) to the usage history.

In step 309, the recommendation engine 103 causes, at least in part, a ranking of the one or more candidate root nodes (e.g., yelp.com), the one or more candidate sub-nodes (e.g., yelp.com/DC), or a combination thereof. In one embodiment, the determination of the one or more candidate root nodes (e.g., yelp.com), the determination of the one or more candidate sub-nodes (e.g., yelp.com/DC), the ranking of the one or more candidate sub-nodes, or a combination thereof is based, at least in part, on the at least one root node score, the at least one sub-node score, or a combination thereof. By way of example, the score of a candidate sub-node must meet a threshold.

In one embodiment, the recommendation engine 103 determines which of the one or more candidate root nodes, the one or more candidate sub-nodes, or a combination thereof has been updated within a time interval (e.g., browsed more times after a day, a week, a month, etc.). The recommendation engine 103 causes, at least in part, an re-calculation of the at least one root score, the at least one sub-node score, or a combination thereof for the one or more candidate root nodes, the one or more candidate sub-nodes, or a combination thereof that have been updated.

In one embodiment, the recommendation engine 103 causes, at least in part, a normalization of the at least one root node score, the at least one sub-node score, or a combination thereof if the at least one root node score, the at least one sub-node score, or a combination thereof exceed a threshold value. By way of example, the at least one sub-node score is normalized to keep a fixed/maximum/minimum amount of URLs in the tree within a threshold. In other examples, the at least one sub-node score is normalized to keep a fixed/maximum/minimum amount of URLs beneath the node within a threshold. As another example, when a max(score) exceeds a predetermined value, the system 100 normalizes the entire tree by adjusting the a value in the formula (5) to avoid overflow.

In one embodiment, the recommendation engine 103 determines the at least one root score iteratively over the at least one sub-node score. The at least one root score for the one or more candidate root nodes is based, at least in part, on a sum of the at least one sub-node scores for the one or more sub-nodes associated with the respective one or more candidate root nodes.

In one embodiment, the recommendation engine 103 causes, at least in part, a calculation at least one entropy score for the at least one root node score, the at least one sub-node score, or a combination thereof. The at least one entropy score represents, at least in part, an uncertainty of the at least one root node score, the at least one sub-node score, or a combination thereof. The recommendation engine 103 causes, at least in part, a pruning of the at least one rood node score, the at least one sub-node score, or a combination thereof based, at least in part, on the at least one entropy score. The determination of the one or more candidate root nodes, the determination of the one or more candidate sub-nodes, or a combination thereof is further based, at least in part, on the pruning. By way of example, the recommendation engine 103 prunes away sibling nodes at issue and the subsequent nodes under the sibling nodes, when the sibling nodes meet the following criterion at a pruning time t Σ score jt (url)<Threshold.

In one embodiment, the recommendation engine 103 causes, at least in part, a calculation of at least one energy score (e.g., via formulas (6)-(8)) for the tree structure, the one or more root nodes, the one or more sub-nodes, or a combination thereof based, at least in part, on the at least one root node score, the at least one sub-node score, the at least one entropy score, or a combination thereof. The ranking of the one or more candidate root nodes, the one or more candidate sub-nodes, or a combination thereof is based, at least in part, on the at least one energy score.

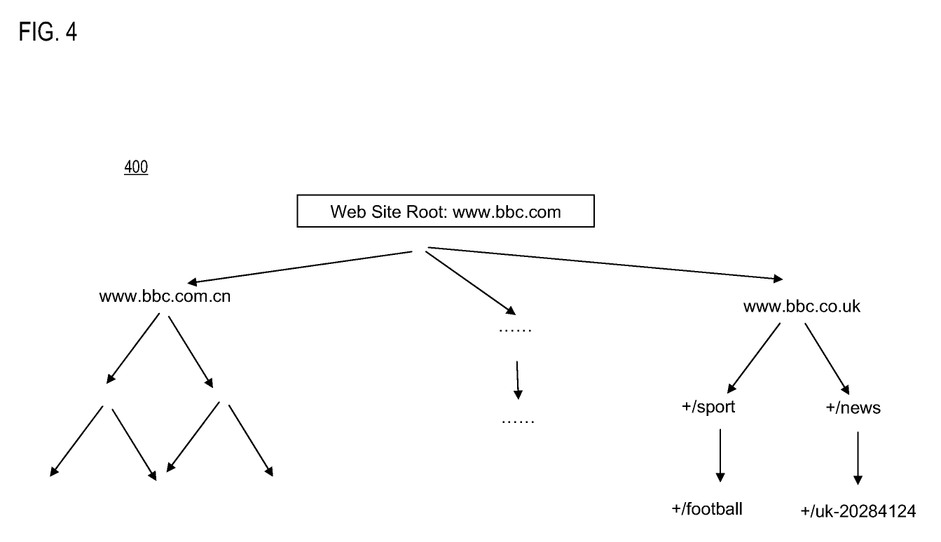

FIG. 4 a diagram of a hierarchical structure of a website, according to one embodiment. By way of example, BBC websites has a tree structure. A user can browse from bbc.com, and then sub-websites bbc.com.cn or bbc.com.uk. Following the latter link, the user then browses deeper into bbc.co.uk/news and bbc.co.uk/news/uk-20284124.

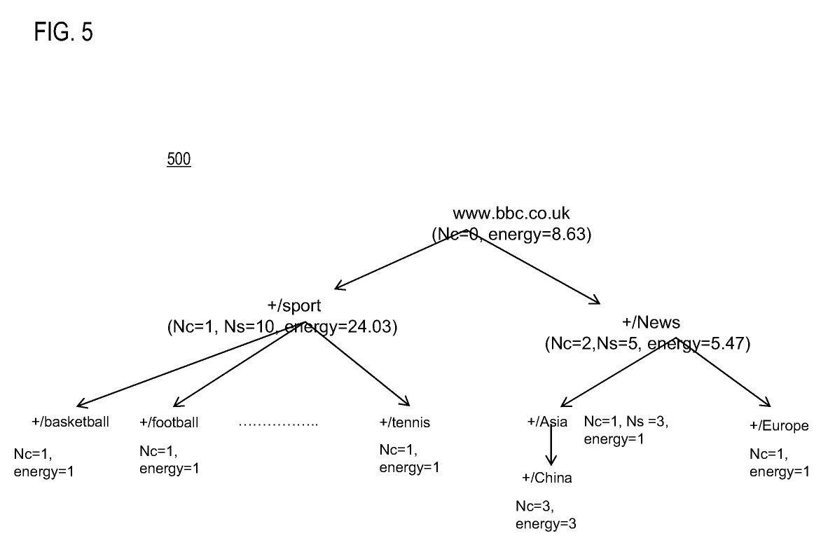

FIG. 5 a diagram of a hierarchical structure of a website depicted with score and energy values, according to one embodiment. By way of example, when a user browses bbc.co.uk/sport once (without browsing the domain bbc.co.uk), and follows the link browsing 10 of the deeper links each once. Each of the leaf nodes bbc.co.uk/sport/basketball, bbc.co.uk/sport/football, etc. has Nc=1, Ns=0, energy=1. The node bbc.co.uk/sport has Nc=1, Ns=10, energy=24.03 as calculated from the above-discussed equations (6)-(8). Thereafter, the user browses bbc.co.uk/news twice, and follows the link browsing other deep links bbc.co.uk/news/Europe, and bbc.co.uk/news/Asia, and then browsing bbc.co.uk/news/Asia/China three times, as show in FIG. 5. The leaf node bbc.co.uk/news/Asia/China has Nc=3, Ns=0, energy=3, the node bbc.co.uk/news/Asia has Nc=1, Ns=3, energy=1, the node bbc.co.uk/news/Europe has Nc=1, Ns=0, energy=1, which lead to the node bbc.co.uk/news has Nc=2,Ns=5, energy=5.47. Since the user did not browsing the domain bbc.co.uk, the root node bbc.co.uk has Nc=0, and energy=8.63 as calculated from the equations (6)-(8). The tree is depicted with the calculation results. From the scores and energy values, it is clear that bbc.co.uk/sport is the best URLs within the domain bbc.co.uk to represent the user's current interest. The system 100 generates the result efficiently with the above-discussed approach.

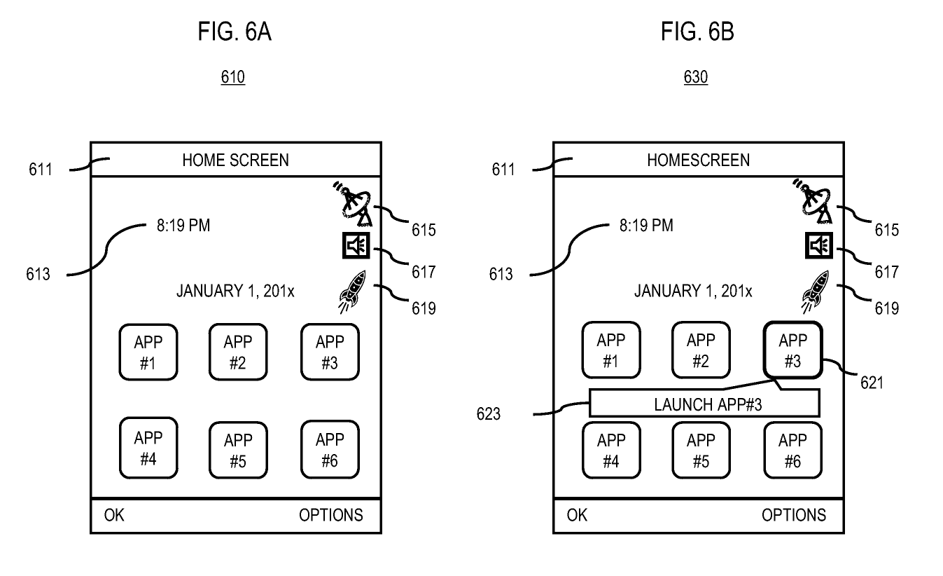

FIGS. 6A and 6B present a homepage (home screen) 610/630 on the user device, according to various embodiments. A title section 611 shows the user interface is for presenting the home screen 610. The home screen features various application short-cut buttons labeled APP #1 through APP #6, for enabling the user to initiate one or more favorite applications. The home screen also presents current time and date information 613. The user may navigate to the homepage 610/630 during execution of the navigation tool. By way of example, per the established settings of FIG. 6B, the navigation tool may call out travel directions to the user as they engage the homepage 610. Resultantly, various indicators 615-619 are caused to be presented to the screen for indicating which resources of the device are being accessed. The icons are representative of the GPS sensor 615, speaker system 617 and accelerometer sensor 619, all of which are activated for acquiring local data.

In FIG. 6B, when the application short-cut button 621 (labeled APP #3) is selected, a pop-up 623 shown to display “Launch APP #3”. In another embodiment, the device may also present a message or prompt to the home screen 630 for presenting an explanation of APP #3. It is noted, by way of example, that the indicators 615-619 may be presented in response to an attempt by the user to initiate the navigation tool.

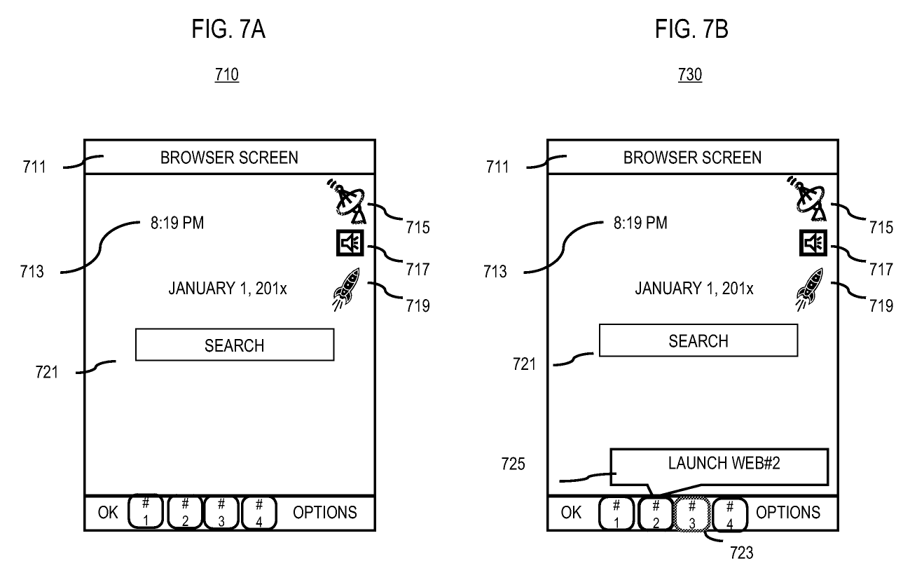

FIGS. 7A and 7B present a browser screen 710/730 on the user device, according to various embodiments. A title section 711 shows the user interface is for presenting the browser screen 710. The browser screen features various application short-cut buttons labeled WEB #1 through WEB #4, for enabling the user to initiate one or more favorite websites. The browser screen also presents current time and date information 713. The user may navigate to the browser screen 710/730 during execution of a web browser. By way of example, per the established settings of FIG. 7B, the navigation tool may call out travel directions to the user as they engage the browser screen 710. Resultantly, various indicators 715-719 are caused to be presented to the screen for indicating which resources of the device are being accessed. The icons are representative of the GPS sensor 715, speaker system 717 and accelerometer sensor 719, all of which are activated for acquiring local data. The user may enter search text into a search field 721 during execution of the web browser.

In FIG. 7B, when the website short-cut button 723 (labeled APP #2) is selected, a pop-up 725 shown to display “Launch WEB #2”. In another embodiment, the device may also present a message or prompt to the browser screen 730 for presenting a thumbnail of WEB #2. It is noted, by way of example, that the indicators 715-719 may be presented in response to an attempt by the user to initiate the navigation tool.

The above-described embodiments provide resource recommendations requiring least amount of user actions (e.g., clicking and typing for internet access) compared to the existed resource recommendation approaches. The above-described embodiments propose algorithm that improves the learning performance. The above-described embodiments improve user experience by recommending favorable websites that better fit the user's expectation. The above-described embodiments generate resource recommendations at personalized favorite granularity levels.

The processes described herein for generating personalized resource recommendations may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

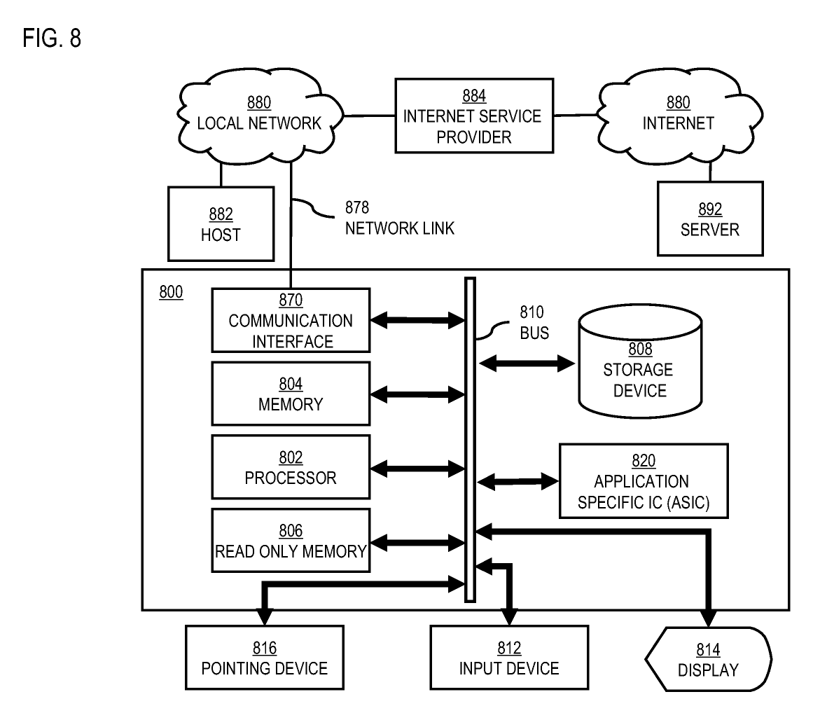

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to generate personalized resource recommendations as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of generating personalized resource recommendations.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to generate personalized resource recommendations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for generating personalized resource recommendations. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating personalized resource recommendations, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for generating personalized resource recommendations to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to generate personalized resource recommendations as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of generating personalized resource recommendations.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generate personalized resource recommendations. The memory 905 also stores the data associated with or generated by the execution of the inventive steps.

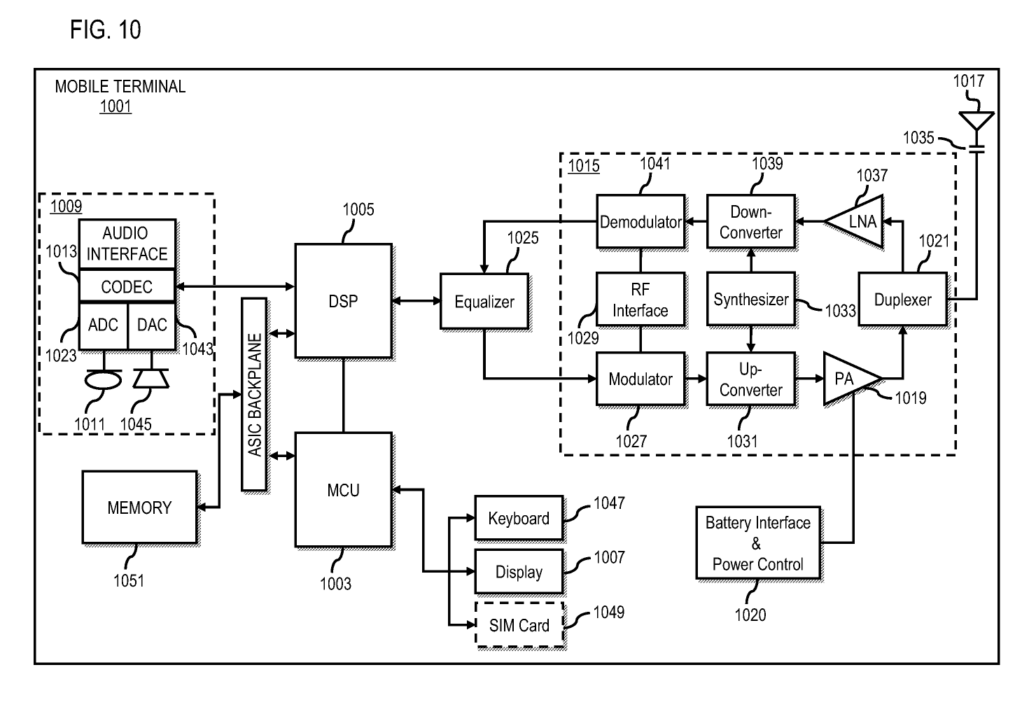

FIG. 10 is a diagram of exemplary components of a mobile terminal (e.g., handset) for communications, which is capable of processing personalized resource recommendations in the system of FIG. 1, according to one embodiment. In some embodiments, mobile terminal 1001, or a portion thereof, constitutes a means for performing one or more steps of generating personalized resource recommendations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of generating personalized resource recommendations. The display 1007 includes display circuitry configured to display at least a portion of a user interface of the mobile terminal (e.g., mobile telephone). Additionally, the display 1007 and display circuitry are configured to facilitate user control of at least some functions of the mobile terminal An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to generate personalized resource recommendations. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-41. (canceled)

42. A method comprising:
causing, at least in part, a classification of one or more items into a tree structure, wherein the tree structure is based, at least in part, on a hierarchical categorization of the one or more items, and wherein the one or more items are associated with a usage history of at least one user;
determining one or more candidate root nodes of the tree structure based, at least in part, on one or more user preference criteria;
determining one or more candidate sub-nodes associated the respective one or more candidate root nodes based, at least in part, on the usage history; and
causing, at least in part, a ranking of the one or more candidate root nodes, the one or more candidate sub-nodes, or a combination thereof.

43. A method of claim 42, further comprising:
causing, at least in part, a calculation of one at least one root node score for the one or more candidate root nodes, at least one sub-node score for the one or more candidate sub-nodes, or a combination thereof based, at least in part, on an application of the one or more user preference criteria to the usage history,
wherein the determination of the one or more candidate root nodes, the determination of the one or more candidate sub-nodes, the ranking of the one or more candidate sub-nodes, or a combination thereof is based, at least in part, on the at least one root node score, the at least one sub-node score, or a combination thereof.

44. A method of claim 43, further comprising:
determining which of the one or more candidate root nodes, the one or more candidate sub-nodes, or a combination thereof has been updated within a time interval; and
causing, at least in part, a re-calculation of the at least one root score, the at least one sub-node score, or a combination thereof for the one or more candidate root nodes, the one or more candidate sub-nodes, or a combination thereof that have been updated.

45. A method of claim 43, further comprising:
causing, at least in part, a normalization of the at least one root node score, the at least one sub-node score, or a combination thereof if the at least one root node score, the at least one sub-node score, or a combination thereof exceed a threshold value.

46. A method of claim 43, further comprising:
determining the at least one root score iteratively over the at least one sub-node score.

47. A method of claim 46, wherein the at least one root score for the one or more candidate root nodes is based, at least in part, on a sum of the at least one sub-node scores for the one or more sub-nodes associated with the respective one or more candidate root nodes.

48. A method of claim 43, further comprising:
causing, at least in part, a calculation at least one entropy score for the at least one root node score, the at least one sub-node score, or a combination thereof,
wherein the at least one entropy score represents, at least in part, an uncertainty of the at least one root node score, the at least one sub-node score, or a combination thereof.

49. A method of claim 48, further comprising:
causing, at least in part, a pruning of the at least one rood node score, the at least one sub-node score, or a combination thereof based, at least in part, on the at least one entropy score,
wherein the determination of the one or more candidate root nodes, the determination of the one or more candidate sub-nodes, or a combination thereof is further based, at least in part, on the pruning.

50. A method of claim 48, further comprising:
causing, at least in part, a calculation of at least one energy score for the tree structure, the one or more root nodes, the one or more sub-nodes, or a combination thereof based, at least in part, on the at least one root node score, the at least one sub-node score, the at least one entropy score, or a combination thereof,
wherein the ranking of the one or more candidate root nodes, the one or more candidate sub-nodes, or a combination thereof is based, at least in part, on the at least one energy score.

51. A method of claim 42, wherein the user preference criteria are based, at least in part, on an access count for the one or more items, a recency of access to the one or more items, a density of access to the one or more items, a decay parameter, an adaption parameter, or a combination thereof.

52. A method of claim 42, wherein the one or more items are associated with one or more Internet domains, one or more subdomains of the one or more Internet domains, or a combination thereof.

53. An apparatus comprising:
at least one processor; and
at least one memory including computer program code for one or more programs, the at least one memory and the computer program code configured to, with the at least one processor, cause the apparatus to perform at least the following,
cause, at least in part, a classification of one or more items into a tree structure, wherein the tree structure is based, at least in part, on a hierarchical categorization of the one or more items, and wherein the one or more items are associated with a usage history of at least one user;
determine one or more candidate root nodes of the tree structure based, at least in part, on one or more user preference criteria;
determine one or more candidate sub-nodes associated the respective one or more candidate root nodes based, at least in part, on the usage history; and
cause, at least in part, a ranking of the one or more candidate root nodes, the one or more candidate sub-nodes, or a combination thereof.

54. An apparatus of claim 53, wherein the apparatus is further caused to:
cause, at least in part, a calculation of one at least one root node score for the one or more candidate root nodes, at least one sub-node score for the one or more candidate sub-nodes, or a combination thereof based, at least in part, on an application of the one or more user preference criteria to the usage history,
wherein the determination of the one or more candidate root nodes, the determination of the one or more candidate sub-nodes, the ranking of the one or more candidate sub-nodes, or a combination thereof is based, at least in part, on the at least one root node score, the at least one sub-node score, or a combination thereof.

55. An apparatus of claim 54, wherein the apparatus is further caused to:
determine which of the one or more candidate root nodes, the one or more candidate sub-nodes, or a combination thereof has been updated within a time interval; and
cause, at least in part, an re-calculation of the at least one root score, the at least one sub-node score, or a combination thereof for the one or more candidate root nodes, the one or more candidate sub-nodes, or a combination thereof that have been updated.

56. An apparatus of claims 54, wherein the apparatus is further caused to:
cause, at least in part, a normalization of the at least one root node score, the at least one sub-node score, or a combination thereof if the at least one root node score, the at least one sub-node score, or a combination thereof exceed a threshold value.

57. An apparatus of claim 54, wherein the apparatus is further caused to:
determine the at least one root score iteratively over the at least one sub-node score.

58. An apparatus of claim 57, wherein the at least one root score for the one or more candidate root nodes is based, at least in part, on a sum of the at least one sub-node scores for the one or more sub-nodes associated with the respective one or more candidate root nodes.

59. An apparatus of claim 54, wherein the apparatus is further caused to:
cause, at least in part, a calculation at least one entropy score for the at least one root node score, the at least one sub-node score, or a combination thereof,
wherein the at least one entropy score represents, at least in part, an uncertainty of the at least one root node score, the at least one sub-node score, or a combination thereof.

60. An apparatus of claim 59, wherein the apparatus is further caused to:
cause, at least in part, a pruning of the at least one rood node score, the at least one sub-node score, or a combination thereof based, at least in part, on the at least one entropy score,
wherein the determination of the one or more candidate root nodes, the determination of the one or more candidate sub-nodes, or a combination thereof is further based, at least in part, on the pruning.

61. An apparatus of claim 59, wherein the apparatus is further caused to:
cause, at least in part, a calculation of at least one energy score for the tree structure, the one or more root nodes, the one or more sub-nodes, or a combination thereof based, at least in part, on the at least one root node score, the at least one sub-node score, the at least one entropy score, or a combination thereof,
wherein the ranking of the one or more candidate root nodes, the one or more candidate sub-nodes, or a combination thereof is based, at least in part, on the at least one energy score.
